(19) United States
(12) Patent Application Publication
(10) Pub. No.: US 2017/0372420 A1
(43) Pub. Date: Dec. 28, 2017

(54) COMPUTER BASED SYSTEM AND METHODOLOGY FOR IDENTIFYING TRADING OPPORTUNITIES ASSOCIATED WITH OPTIONABLE INSTRUMENTS

(71) Applicant: Newport Exchange Holdings, Inc., Irvine, CA (US)

(72) Inventors: Steven Albin, Irvine, CA (US); Jose Antonio Blasco Momparler, Valencia (ES)

(73) Assignee: Newport Exchange Holdings, Inc., Irvine, CA (US)

(21) Appl. No.: 15/196,001

(22) Filed: Jun. 28, 2016

(51) Int. Cl. G06Q 40/04; G06Q 30/06

(52) U.S. Cl. CPC G06Q 40/04; G06Q 30/06

(57) ABSTRACT

The system and methodology of the present invention operate to generate option valuation determinations as well as proposed trading strategies based thereon. In making these determinations, the system assesses the high and low points for historic volatility for the underlying asset over some pre-determined historical timeframe. Next, the range of historical volatilities over that time frame is divided into a number of levels against which current, present implied volatility of the underlying asset can be compared. The system may display/report the determined valuations for various selected options for manual user action in setting up trades based thereon. In other embodiments, the system of the present invention may generate recommended trades involving one or more options based on the novel valuation determinations made by the system of the present invention. These trades are designed to take advantage of perceived incongruities between an available price for an option and its true value according to the novel assessment undertaken by the system of the present invention.

### RELATED APPLICATIONS AND SUBJECT MATTER

This application is related in subject matter to application Ser. No. 14/681,171 filed Apr. 8, 2015, entitled “Computer Based Trading System and Methodology for Identifying Trading Opportunities,” currently pending and assigned to the same assignee as the assignee of the present application. This application is also related in subject matter to U.S. Pat. No. 8,650,115, issued on Feb. 11, 2014 to the same assignee as the assignee of the present application. The subject matter of both application Ser. No. 14/681,171 and U.S. Pat. No. 8,650,115 are expressly incorporated herein.

### FIELD OF THE INVENTION

The present invention is directed generally to systems and methodologies for effectively trading optionable instruments and more particularly to systems and methodologies which are designed to provide traders with enhanced capabilities for the implementation of strategies employing such optionable instruments at profitable pricing levels.

### BACKGROUND OF THE INVENTION

While there is some variance depending upon the state of the economy and market conditions in general, the volume of securities traded on various worldwide markets and exchanges is exceedingly large and getting larger. Securities in this context can be any of a number of financial instruments such as stocks, bonds, mortgage backed securities, options, or, alternatively, hard assets such as precious metals, commodities and the like. The common element among these widely traded vehicles (hereinafter collectively referred to as “securities” for ease of reference), however, is that they enjoy a great deal of liquidity and the markets in which they trade are well established with many different buyers and sellers who participate in buying and selling the applicable security.

When there are a large number of buyers and sellers, the market for that security tends to be more active and perhaps more importantly, the spread between the available purchase price (the “ask”) and the available selling price (the “bid”) tends to be narrower. This in turn encourages buyers and sellers to participate in the buying and selling of that security since they are less likely to overpay or sell for too low of a price solely because of the “transaction cost” associated with the buy/sell spread which is incurred in executing the buy or sell transaction. Additionally, markets for securities tend to be more active where commissions and/or other fees and charges associated with the purchase and sale transaction are lower since the collective costs incurred from such costs and the bid/ask spread directly impact the profitability of trading that security.

In addition to minimizing transaction costs, profitable trading necessarily involves the need to purchase securities at a lower cost than the price at which the security is ultimately sold. Or, in the case of short selling, it is necessary to first sell the security at a higher cost than the price at which the security is ultimately covered. There are various known techniques, systems and methodologies for attempting to do just this. For example, some traders (typically individuals or “retail” traders as opposed to professional or “institutional” traders) will trade manually, largely based on nothing more than a gut feel. Alternatively, various individuals and even sophisticated individuals and institutional traders will use manual “systems” under which they devise a plan to make specific trades under various circumstances and market conditions. For example, such a trading plan may be as simple as buying XYZ stock when it sells for a price of $40 or lower (ask at $40 or below) and selling that same stock which it sells for a price of $44 or above (bid at $44 or above).

The foregoing plan may be implemented as a simple trading policy that a trader manually follows by entering appropriate buy and sell orders at the appropriate times. Or, the trader may utilize an online broker that provides the functionality for the trader to enter standing orders to make these trades when the specified market conditions are met. As yet another example, the trader may employ a software based tool that interacts and communicates with his or her brokerage trading platform to execute trades consistent with trading system rules. Other applications and services are also available which offer traders the ability to implement their own trading plan and/or plans and strategies developed by third parties.

The trading plan described above is generally considered to fall within the class of trading methodologies referred to as “technical analysis”. In this class of trading methodologies, specific decisions are made based solely on historic price movement for the underlying security as well as expected future price movement based on mathematical analysis tied to price/time chart movements. Technical analysis techniques for predicting and acting upon expected future price movement are in widespread use by retail and institutional traders.

This class of techniques and the systems that implement them, however, do suffer from a number of drawbacks. For example, in many cases, a great many competing traders are using the same systems with the same predictive algorithms and are acting upon these predictions generated by these systems at the same time. At a market based level, this produces undesirable outcomes for these traders since they are competing at the same time to buy a security with others using the same algorithms based on the same predictions at the same time. Further, they are also competing against each other when the system indicates that the trader should sell a security. In both of these cases, an artificial demand (buy signal) or supply (sell signal) is created which tends to move the price up or down, respectively beyond what it would otherwise be and thus resulting, in theory, in a less profitable trade for each of the traders using the same system.

Another disadvantage of technical analysis is that, by definition, it is based on price movement that has occurred in the past and this information is used to predict price movement for the future. Unfortunately, it is theorized that price movement is largely random and instead driven only by supply and demand which exists in real time as opposed to what has happened in the past. The net result of this is that technical analysis tools, while they can be useful, are often times not the ideal predictor of future price movement.

Another class of trading techniques which are in use are those known as “fundamental analysis”. This class of techniques relies on examining the fundamental properties of the asset underlying the security. For example, for a common stock associated with a company, trading decisions may be based on earnings, revenue and/or newsworthy events about that company's positioning within its industry. A practically unlimited number of other metrics may be used as well. More common examples include price to earnings ratios, level of debt, earnings growth, deals expected to add to revenue in the future, etc. In the case of securities which represent ownership in hard assets such as gold, oil, etc., trading decisions using fundamental analysis might include such metrics as predicted demand for the underlying asset, predicted supply, newsworthy stories regarding the applicable asset such as new oil wells being drilled, disruptions in the supply chain for bringing the asset to the end user, etc.

While fundamental analysis based decisions and the systems that implement them also have their place in trading, they also suffer from drawbacks. For example, notwithstanding a very good understanding of a company and its financial picture, the market for stock representing ownership in that company may depart from the realities of the value of that company. This is evidenced by the fact that all stocks do not, for example, trade at the same multiple of earnings. There are other factors that go into the real time price for a stock that can not be addressed by fundamental analysis. Examples include “buzz” about certain companies and industries, rumors concerning that company, and other intangible aspects of the value of a particular stock that can not be measured or predicted using known fundamental analysis techniques.

There exist a number a software tools for trading securities and other assets whereby one or more trading strategies are applied and a user is presented with one or more possible trades (typically a buy, sell, sell short or cover signal) that may be timely based upon market conditions and the specific trading strategy applied. Unfortunately, various drawbacks exist with these tools. In some cases, these tools do not function on a real time or even on a timely basis such that by the time the potential trades are presented, they may no longer be good trades or trades that otherwise comply with the rules of the applicable trading system. In other cases, these tools do not present all available trades in a manner that is easily understood or actionable by a user.

There also exist other drawbacks with these systems. Some of these systems may simply present trades that are generated by applying the rules of the trading system(s) but which are not specifically tailored for the user based on the user's risk tolerance, available capital, current positions, personal strategy and/or whether the user is seeking current income, medium term results or a strategy designed to generate long term wealth.

In addition to the above stated issues that generally apply to trading associated with a broad class of instruments, current techniques for trading associated with options and other derivative instruments present additional issues. A great majority of option trading methodologies utilize techniques to assess whether particular options are fairly valued, overpriced or underpriced at the time of the proposed trade. Based on this assessment, one or more option trading strategies may be implemented in an attempt to leverage the assessment with the goal of achieving a profitable trade.

For example, if an option is viewed to be undervalued, a strategy as simple as buying that option can be implemented. More complex strategies such as spreads and straddles can also be implemented with the associated purchases and sales of the individual options being dictated by the valuation assessment for each option involved in the trade.

One of the most common techniques for assessing the value of an option involves comparing an option's historic volatility (HV) as against that same option's implied volatility (IV). Both HV and IV are calculated using known models such as the Black-Scholes model. At any one time when considering a trade, (i) the current present value of HV, which is a mathematical calculation that uses past price action in order to measure speed of movement for the underlying asset (e.g. a stock from which the option derives) is measured; and (ii) the current present value of IV, which is extracted from the current present options prices themselves and represents the expected movement into the future, is also measured.

Once both HV and IV are determined, they are compared to each other and market participants will typically assume that when current present IV values are greater than current present HV values, then options would be overpriced and when current present IV values are lesser than the current present HV values, then options would be underpriced.

This approach, however, is not ideal in that the HV value calculated as noted above may not truly reflect the best value for use in connection with trading decisions based on comparing such HV value to a present IV value. In particular, a first issue associated with the HV value calculation is that the use of past data generates a lagging effect and therefore current present HV values are not ideally representative of the true historic volatility associated with an asset over a desired time period in the past.

Another issue with the calculation as typically conducted is that current present HV values represent the speed of movement in the recent past, but financial markets change their speed of movement through time depending on market cycles, meaning that a more useful measurement would be to identify extreme characteristics of those particular financial markets when they were moving the fastest or the slowest instead of focusing on the current present lagging measurement of speed which is not an ideal representation.

Additionally, in performing the valuation by comparing HV to IV, the comparing of current present non-lagging IV values to current present lagging HV values is inappropriate and undermines the valuation of the option. This, in turn, undermines the likely success of the selected trading strategy since it is not based on a valuation that reflects the reality of the underlying instrument's movement or the true value of the options to be used in the trading strategy.

### SUMMARY OF THE INVENTION

It is thus a primary object of the invention to provide a system and methodology that addresses the shortcomings of the prior art as discussed above.

It is another object of the present invention to provide a system and methodology which provides traders with current indicators designed to achieve improved trading results when trading a wide variety of securities, commodities and any other instrument which provides at least a reasonable degree of liquidity.

It is a still further object of the present invention to provide a computer based trading system that applies one or more known trading systems to a defined universe of tradeable instruments to generate a listing of possible trading actions available to a user on a timely basis.

It is an even further object of the present invention to provide possible trading actions in a robust and highly configurable environment such that a user and/or system administrator can apply one or more filters to limit possible trading actions to those that meet one or more applied characteristics.

It is a still further object of the present invention to provide a list of possible trading actions that also allows a user to select one or more such possible actions and act upon such selected actions in the form of a trade execution.

It is a yet further object of the present invention to provide a computer based trading system that notifies users of possible trading actions on a timely basis via one or more methods such as email, web based notifications and/or SMS texts.

It is a still further object of the present invention to provide a computer based trading system with novel reporting and display functionality such that possible trading actions are displayed in an easily readable and organized fashion through various differing display formats.

It is a still further object of the present invention to provide a computer based system and method which has unique applicability to the trading of derivative instruments based on optionable asset classes such as stocks, futures, currencies and others.

It is an even further object of the present invention to provide such a computer based system that generates potential trades that are more likely to be profitable as against prior art options trading systems which employ an unrealistic assessment of historic volatility.

It is a yet further object of the present invention to provide such a computer based system for generating such potential trades wherein the assessment for historic volatility of an asset underlying an option is based upon an expanded range of a values representing highest and lowest volatility values over a pre-defined historic period such as the prior 52-week period.

It is a still further object of the present invention to compare this improved assessment of historic volatility against current, present implied volatility for an applicable optionable asset in order to more effectively determine the relative valuation of one or more options under consideration for a trading strategy.

It is an even further object of the present invention to provide a computer based system and methodology which employs the aforementioned relative valuation assessment in order to recommend potentially profitable trading strategies employing one or more options.

A primary objective of the invention disclosed herein is a computer based system and methodology which effectively applies an objective set of rules that use pertinent comparable volatility values and that allows for the definition of very precise levels of indicated options price inflation/deflation. This, in turn, leads to a system capability in which a specific set of options strategies may be fine-tuned through the use of parameters which are indicative of the level of perceived options inflation or deflation.

The system and methodology of the present invention operate to generate option valuation determinations as well as proposed trading strategies based thereon. In making these determinations, the system assesses the high and low points for historic volatility for the underlying asset over some pre-determined historical timeframe. Next, the range of historical volatilities over that time frame is divided into a number of levels against which current, present implied volatility of the underlying asset can be compared. These levels represent the extent to which the current, present implied volatility, when falling within one of these levels, would be viewed as undervalued or overvalued.

In some embodiments, the system may display/report the determined valuations for various selected options for manual user action in setting up trades based thereon. In other embodiments, the system of the present invention may generate recommended trades involving one or more options based on the novel valuation determinations made by the system of the present invention. These trades are designed to take advantage of perceived incongruities between an available price for an option and its true value according to the novel assessment undertaken by the system of the present invention. Such trades generally reflect strategies wherein overvalued options are sold and undervalued options are purchased in some combination.

In some embodiments of the present invention, the computerized system and methodology disclosed herein also provides the ability for users to timely update pending trades based on changes in market conditions as assessed by the system of the present invention in real time or in near real time. Through constant or near constant assessment of option valuation, the system of the present invention can notify users of actions that are recommended for implementation based on changing market conditions as compared to the establishment of the initial trade and/or the last adjustment made in connection with the trade. Various parameters to include the thresholds at which trade adjustments are recommended for implementation may be set by a user and/or a system administrator. In some embodiments, the system of the present invention may automatically invoke these recommended adjustments without any action being required from the user.

The system may also permit a user to act on one or more potential trades through the interface presentation, by, for example, clicking on a displayed link. The system may also be configured by a user so as to cause the system to behave in a way that is customized for the user independent of the specific trading strategies applied. For example, the user may configure the system to provide notifications of actionable trades on a desired frequency such as real time, at market open and/or at various points during a trading day for the instrument.

### BRIEF DESCRIPTION OF THE DRAWINGS

FIG. 1 is a diagram depicting the major components of the system of the present invention including the trading opportunity presentation system (TOPS) of the present invention in a preferred embodiment thereof;

FIG. 1A is diagram depicting the major components of the supply and demand sub-system of the present invention in a preferred embodiment thereof;

FIG. 2 is a diagram depicting an exemplary classification scheme for assessing implied volatility according to a preferred embodiment of the present invention;

FIG. 3 is an exemplary screenshot illustrating the assessment of options valuation according to the present invention in a preferred embodiment thereof;

FIG. 4 is a tree diagram showing potential options strategies that may be implemented and/or recommended by the system of the present invention according to a preferred embodiment thereof;

FIG. 5A is a diagram illustrating option valuation and potential strategy adjustment based on negative Vega values according to a preferred embodiment of the present invention;

FIG. 5B is a diagram illustrating option valuation and potential strategy adjustment based on positive Vega values according to a preferred embodiment of the present invention;

FIG. 6 is an exemplary screenshot showing the use of option valuation and Vega value adjustment based on a change in underlying market conditions; and

FIG. 7 is a flowchart illustrating the steps associated with the process of the present invention as may be executed by the system of the present invention in a preferred embodiment thereof.

### DETAILED DESCRIPTION OF THE INVENTION

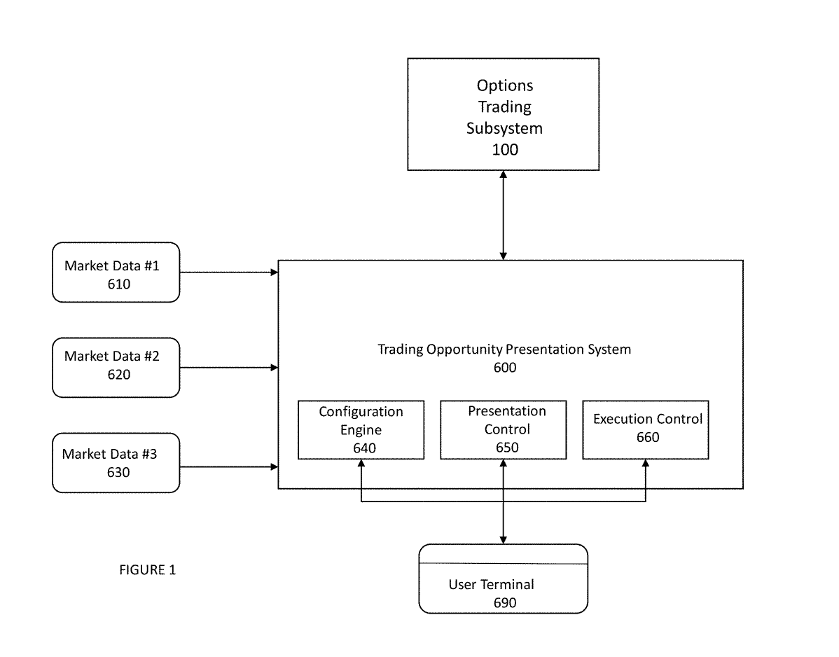

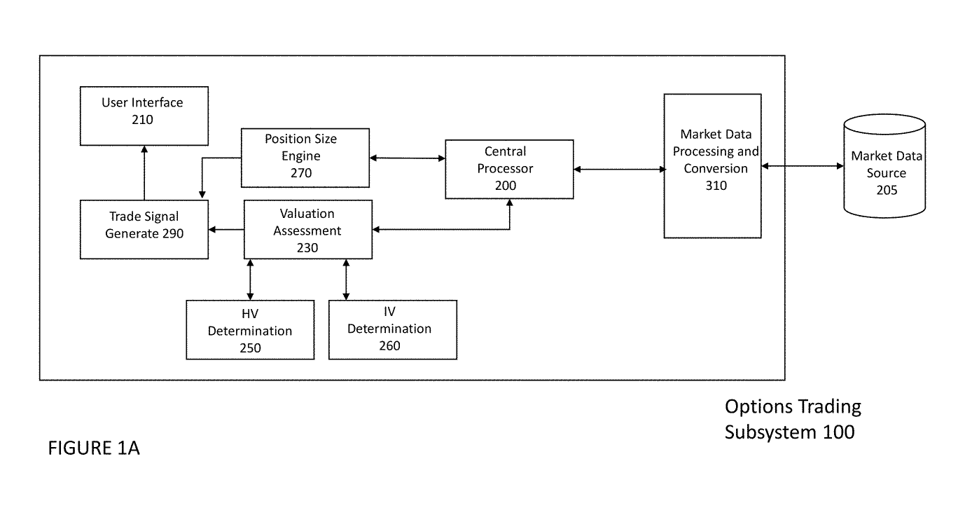

With reference now to FIG. 1, the system of the present invention, in a preferred embodiment thereof, is now described. Trading Opportunity Presentation System (TOPS) 600 is preferably a computer based system for implementing the functionality of the present invention as described in greater detail below. While an exemplary architecture is described, it will readily be understood by one of skill in the art, that an unlimited number of architectures and computing environments are possible while still remaining within the scope and spirit of the present invention.

TOPS 600 and Options Trading Subsystem 100 may operate on one or more servers and may communicate with each other through electronic communication links. The servers may include electronic storage, one or more processors, and/or other components. The servers may also include communication lines, or ports to enable the exchange of information with a network and/or other computing platforms. The servers may include a plurality of hardware, software, and/or firmware components operating together to provide the functionality attributed herein to TOPS 600 and Options Trading Subsystem 100.

Electronic storage associated with the servers may comprise non-transitory storage media that electronically stores information. The electronic storage media of electronic storage may include one or both of system storage that is provided integrally (i.e., substantially non-removable) with servers and/or removable storage that is removably connectable to the servers via, for example, a port or a drive.

Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from servers, information received from user terminals 690, and/or other information that enables the servers to function as described herein.

Options Trading Subsystem 100 generates potential trades according to a volatility determination and comparison process as further described below in connection with FIG. 1A. Options Trading Subsystem 100 communicates with TOPS 600 so that TOPS 600 can request and receive potential trades as well as issue various commands and provide selections and other data to Options Trading Subsystem 100. Each of Options Trading Subsystem 100 and TOPS 600 may comprise one or more modules, software programs and/or processes running on one or more computers such as servers, desktop or laptop computers, handheld devices or any other computing platform or hardware device.

TOPS 600 further has access to one or more market data sources. These are illustrated in FIG. 1 as Market Data #1 (610), Market Data #2 (620) and Market Data #3 (630). However, there may be more or less sources of market data available to TOPS 600. Further, communication with market data sources may be one way (periodic transmission of market data from the applicable source to TOPS 600) or two-way whereby TOPS 600 may periodically request market data from one or more market data sources and/or periodically receive market data without making a specific request. Market data sources (610, 620 and 630) may be any source of market data respecting one or more categories of tradable instruments for which TOPS 600 may generate and display potential trades. For example, market data sources may comprise real time and/or near-real time feeds for stocks, bonds, currencies, commodities, options, and other derivatives tradable instruments. These market data sources preferably provide data on a real time basis during active trading of the applicable instruments although, in some cases, data less frequent than real time data may be used particularly in the case of trades being generated for medium and longer term strategies. In one embodiment of the present invention, market data sources may be obtained through commercial services such as Tradestation™ and/or other platforms through which such data may be obtained.

TOPS 600 may be accessed through one or more user terminals 690. Although only one user terminal 690 is shown in FIG. 1, in typical practice, multiple user terminals will be accessed by multiple users/subscribers to access the information made available to users by TOPS 600. These user terminals 690 may be one of various computing platforms such as PC's, laptops, smartphones, tablets and/or other fixed or mobile devices through which a user may interact with TOPS 600. Preferably, user terminals 690 include a display screen and an input means such as a keyboard and/or a pointing device such as a mouse. User terminals 690 may communicate with TOPS via various known communications links and protocols such as through the internet, VPN as well as other public and private networks.

The primary components of TOPS 600 are now described at a high level with further details and examples provided elsewhere in this specification. These components may, in one embodiment, include configuration engine 640, presentation control 650 and execution control 660. Again, these components preferably comprise one or more software modules running on a computer platform such as a server based system.

At a high level, configuration engine 640 receives and processes commands from users via user terminals 690 regarding specific configurations desired by users in connection with potential trades provided to users. For example, users may interact with configuration engine 640 in order to specify one or more filters desired to limit potential trades provided. This might include only trades relating to stock based derivative instruments (i.e. options), only trades relating to specific stocks, only trades relating to stocks/options with specific trading values as well as almost any other criteria that might be available through TOPS 600. In addition to or alternatively to users/subscribers, filters and other configuration selections may be made and selected by administrators working on behalf of a company operating TOPS 600 potentially as a service to users. These administrators may access configuration engine 640 and make configuration selections via terminals similar to user terminals 690 or other devices which permit interaction with TOPS 600 generally and configuration engine 640 more specifically. More detail on filters, selections and configuration of the system generally and by individual users is provided below.

Presentation control 650 may be another software module operating as a component of TOPS 600. Again, at a high level, presentation control component 650 operates to control the specific data and form of display presented to user in connection with potential trades which may be available to a user as may be displayed on user terminal 690. Presentation control 650, as directed by a user or an administrator, or both, may display information in the form of a chart, a graph, some combination and/or other forms of data display which is desirable by a user in order to efficiently and effectively present a set of available trades that may be available in a given time frame based on specified criteria.

Presentation control 650, may, in a preferred embodiment, also operate to control the vehicle by which a user may obtain trading information at user terminal 690. For example, and as more fully described below, presentation control, as directed by users and/or administrators, may alert users to potential trades via a web based display, an email notification, an SMS text, an automated phone call and/or other methodologies as may be selected by users and administrators. More detail regarding types of notifications and related presentation is provided below.

Execution control component 660 may be included in TOPS 660 as an additional module to permit users to select and act upon one or more potential trades made available to user by TOPS 600. Thus, for example, a user may be presented at user terminal 690 with ten potential trades satisfying the user's criteria as specified via interaction with configuration engine 640 as well as meeting the primary criteria of the trading system implemented by Options Trading Subsystem 100. A user may select one of these trades for execution through interaction with execution control component 660. Although not shown in FIG. 1, execution of any such trades would require interaction with and communication of selected trade information to a trading platform and/or directly to an exchange so that selected trades may be executed.

Now that a high level description of TOPS 600 has been provided, the specific aspects of the novel trading methodologies implemented by Options Trading Subsystem 100 are discussed. Following that description, the discussion then continues with the novel aspects of TOPS 600 including the various aspects of the system using and leveraging the trading opportunities generated by Options Trading Subsystem 100 including various examples of screening capabilities, novel approaches for presenting the potential trades to users including ways in which both the system approach required by the methodologies of Options Trading Subsystem 100 and the unique selection criteria of users can be combined to identify, display and select preferred trading opportunities uniquely tailored to each of the users. For example, during any specific time window and from the universe of potential trades generated using the options trading strategies implemented by Options Trading Subsystem 100, additional user criteria may be applied to tailor presented trading opportunities further to a user's desires including those reflecting risk tolerance, investment horizon, category of tradable instruments as well as other selection criteria.

With reference now to FIG. 1A, the major components of Options Trading Subsystem 100 are now described. Options Trading Subsystem 100 is preferably implemented on a general purpose computing platform such as a server computer which has sufficient processing power and input/output capabilities to support multiple sessions with multiple users accessing Options Trading Subsystem 100 simultaneously. At the heart of this computing platform is central processor 200 which manages and executes all processes hereinafter described. User interface 210 serves to provide the interface between Options Trading Subsystem 100 and user terminals such as user terminal 690 in FIG. 1 (not shown in FIG. 1A) to the extent that users may directly interact with Options Trading Subsystem 100 as well as other components of TOPS 600. This may include formatting data for transmission and display by user terminals 690 as well as receiving data from terminals 690 and formatting and/or converting such data in a manner such that it is usable by Options Trading Subsystem 100.

Trade signal generation functionality 290 represents a set of processes which collectively generate trading signals such as buy and sell signals and recommended options trades which result from the execution of algorithms and processes which are resident within Options Trading Subsystem 100, such algorithms and processes being described in detail below. Trade signals and recommended options trades are generated by trade signal generation functionality 290 as and when commanded by central processor 200 and such signals are communicated to TOPS 600. So, for example, if a signal to enter a specific options trade (such as, for example, a calendar spread) results from one of the processes resident within Options Trading Subsystem 100, central processor 200 ensures that that signal is generated by trade signal generator 290 and communicated to TOPS 600.

Options Trading Subsystem 100 further preferably includes a number of functional components that execute the novel processes of the present invention which are designed to leverage novel techniques for determining the volatility of assets which underlie options and other derivatives. In this way, a more accurate assessment of valuation for these derivatives can be made resulting in the ability to provide proposed trades involving derivative which are likely to be more profitable. These assessments can be employed not only at the initial setup and entry into the trade but also as the position(s) are maintained as market conditions change.

One of these functional components is HV determination engine 250 which employs the novel methodologies of the present invention to provide a more accurate assessment of historic volatility for an underlying asset according to preferred embodiments of the present invention which are described in detail below. Similarly, IV determination engine 260 determines the current, present implied volatility of an underlying asset according to the teachings of the present invention in a preferred embodiment thereof.

Valuation assessment engine 230, which is under the control of central processor 200, performs a number of functions using inputs from HV determination engine 250 as well as IV determination engine 260. In particular, valuation assessment engine 230 first uses the high and low historic volatility levels (HV) for an applicable underlying asset to create a number of “valuation zones” associated with the derivative instrument and spanning different pricing levels. In a preferred embodiment of the present invention there are five such zones although the invention is not necessarily limited thereto and any reasonable number of zones may be used.

According to this preferred embodiment, the five zones represent derivative/option valuation zones as follows: very deflated, deflated, fair, inflated and very inflated. In a preferred embodiment of the present invention, these zones represent equally sized zones at different pricing levels (e.g. very deflated might be prices from 1 up to 5, deflated may be prices above 5 up to 9, fair may be prices above 9 up to 13, inflated may be prices above 13 up to 17 and very inflated may be prices above 17 and up to 21). However, it will be readily understood by one of skill in the art that in addition to increasing or decreasing the number of zones, the “width” of each zone may be varied and not necessarily equivalent to the other zones without departing from the scope or spirit of the present invention.

Once these zones have been determined, valuation assessment engine 230 employs the input provided from IV determination engine 260 to assess the current, present implied volatility of one or more derivative instruments (e.g. options) and value that one or more derivative instruments by placing each on one of the valuation zones. Placement is made by comparing the implied volatility of each applicable option as against the high and low values in each of the valuation zones determined as mentioned above. When the implied volatility of the derivative falls between the high and low pricing values assigned to a specific zone, the applicable derivative is placed within that zone and valued as such.

As will be discussed in further detail below, this means that based on historical price movement of an underlying asset (e.g. Stock XYZ) over some pre-determined historical time frame (e.g. the previous 52-week trading period), a specific derivative instrument based on that underlying asset (e.g. an August 2016 60 call) is currently priced as either very deflated/very undervalued, deflated/undervalued, fairly priced, inflated/overvalued or very inflated/very overvalued.

Once valuation assessment engine 230 has made the required valuation assessment for the desired derivative instruments (for example, all put and call options currently available which tie to the underlying stock XYZ), trade signal generation engine 290 uses this information to generate one or more possible derivative strategies that can be recommended for entry and/or adjustment of existing positions. These recommendations are expressly based on the valuation determinations made by valuation assessment engine 230.

By way of example and as will be discussed in greater detail below, it may be determined by valuation assessment engine 230 that a subset of call options deriving from stock XYZ are in the very deflated zone while a subset of put options also deriving from stock XYZ are in the very inflated zone. In this case, trade signal generation engine may recommend a trade that involves selling some or all of the put options while at the same time buying one or more of the call options. One recommended trade based on this outcome might be a long combination trade which is also known as a synthetic long stock trade.

Position size engine 270, under the control of central processor 200, may be optionally included within Options Trading Subsystem 100. Position size engine 270 serves to determine, based upon a specific trader's available capital and risk tolerance, the recommended position which should be purchased and/or sold in connection with the trading signals which are generated by Options Trading Subsystem 100. Market data processing and conversion functionality 310 receives market data from one or more external sources and processes and formats this information so that it can be used by the other functional components of Options Trading Subsystem 100 such as HV determination engine 250 and IV determination engine 260. As noted above, market data may also be fed directly to TOPS 600 and Options Trading Subsystem 100 may obtain market data in that manner and/or from market data sources 205 shown in FIG. 1A. Examples of such data include real time market feeds associated with a great many tradable instruments of interest to and/or currently being traded by users of Options Trading Subsystem 100. For example, this market data may comprise real time streaming data of price levels associated with various stocks, bonds, commodities, currencies, etc. as well as various derivative instruments based thereon (e.g. futures, options, etc.) as such data is made available by the relevant markets as well as third party data providers. In a preferred embodiment, this data represents the most accurate and current data available with respect to the tradable instruments so that signals generated by Options Trading Subsystem 100 are accurate, timely and actionable.

Now that the system of the present invention and its various components, in a preferred embodiment thereof, have been described, the novel teachings of the present invention with respect to the various methodologies employed to generate derivative/options valuations as well as trading signals and recommended trading strategies will now be discussed. It will be noted that in the following discussion the terms derivative and option will be used interchangeably. It will be understood by one of skill in the art that while much of the discussion references the trading and valuation of options, the teachings of the present invention can be readily applied to any other derivative instrument which derives from an underlying asset.

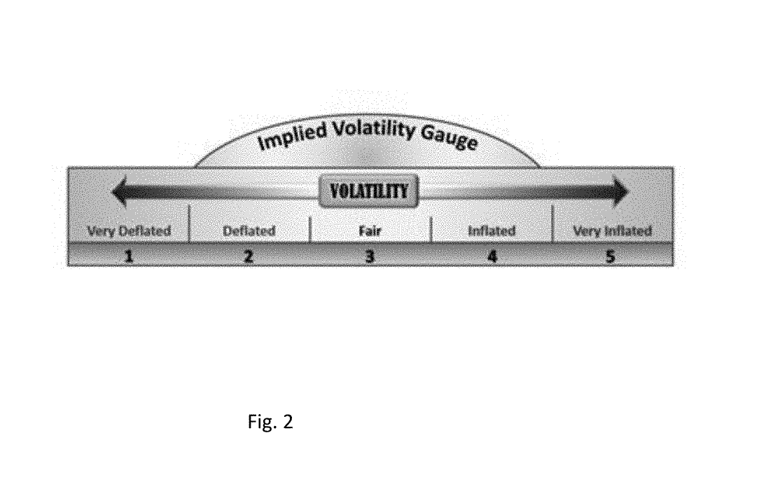

With reference to FIG. 2, an implied volatility gauge is shown. As discussed above, this Figure provides a graphical view of the various zones into which an option may be placed with respect to its current valuation as determined by options trading subsystem 100 in one embodiment thereof. Of course, there may be more or less zones than shown while remaining within the scope and spirit of the present invention. In this case the zones, which represent pricing zones range from zone 1 (very deflated) to zone 5 (very inflated) with zones 2 (deflated), 3 (fair) and 4 (inflated) also being used. Again, each option under consideration for purchase or sale (either individually or as part of a multi-option strategy) is placed into one of these zones based upon a comparison of the option's current IV as against the HV range determined by HV determination engine 260 according to the novel methodology of the present invention.

The pricing zones are determined, as discussed above, based on the highest and lowest level of price movement attributable to the underlying asset over a predetermined historical period. For example, this may be the highest and lowest volatilities attributable to the underlying asset over the previous 52-week period. Other longer or shorter periods may alternatively be used. In one embodiment, this range is then divided into equal price range zones lying between the previously determined high and low volatility values. As discussed above, if an option's current IV places it in an inflated or very inflated pricing zone, the option may be recommended for a sale. In addition, or alternatively, that option valuation may cause that option to be recommended for a sale as just once component of an overall strategy (e.g. sell that option while buying other options that are valued by valuation assessment engine 230 as being very deflated or deflated).

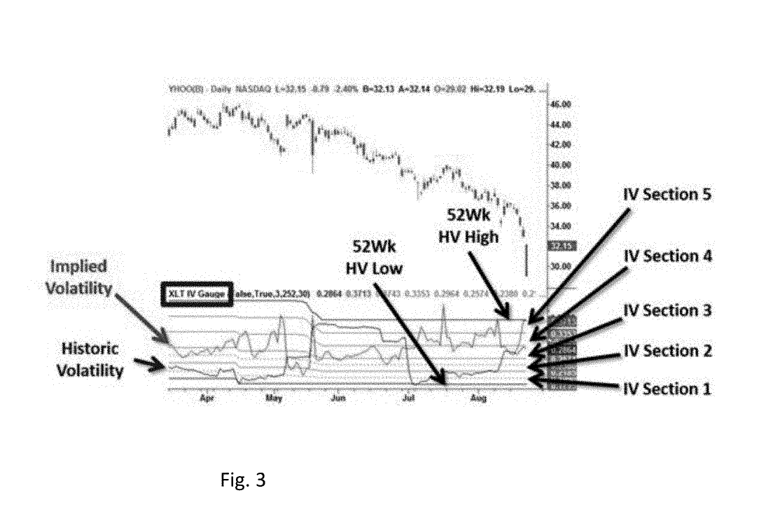

Turning now to FIG. 3, a diagram showing the methodology for assigning pricing zones in more detail is provided. In this Figure, a plot showing the price movement of the underlying asset—Yahoo stock—using candlesticks, is included. The time frame for this plot is approximately 52 weeks from September to September (although the months from September through part of March are not shown) indicating an exemplary historical volatility period according to the teachings of the present invention. In this case, the line identified as “Historic Volatility” ranges from a low around the beginning of July to a high around late May. It is assumed that there are no higher highs or lower lows during the time period not shown in the plot. According to the teachings of the present invention, the two exact low and high points are used as the bounds for the overall range (noted in the Figure as 52 Wk HV Low and 52 Wk HV High).

The Historic Volatility of a particular underlying asset (e.g. Yahoo stock) may be calculated at any one time according to known methodology such as by calculating the annualized standard deviation of the historical daily price changes for the asset. In other words, it is a reflection of how much the stock price fluctuated on a daily basis during the previous year. This leads to the plot shown in FIG. 3. In this example, the HV level (the Y-axis in the figure) is then divided into five equal ranges of volatility values.

The Implied Volatility of the underlying asset reflects the projected potential movement of the asset's price on a going forward basis. Essentially, this is reflected in the fact that the IV predicts what the stock is likely to do in terms of price movement through the expiration of the applicable options contract. IV is derived from each applicable option's price and illustrates what the market implies about the stock's volatility in the future. The IV determined by IV determination engine 260 is based on a collective set of Implied Volatilities using various options associated with the underlying asset and tending to focus on At The Money (ATM) options. For example, in one embodiment, IV determination engine may use the ATM option as well as two strikes above and below the ATM option for a total of five options which can be averaged according to a weighting based on each option's delta value.

In FIG. 3, it can be seen that the IV plot varies with respect to the HV over time. In some cases, it is higher than the HV value and at other times it is lower. Most relevant is the location of the IV value at the current time (the time that the trade is being considered) and which of the IV zones it falls into. In the case of FIG. 3, it can be seen that in late August/Early September, the IV value falls well within IV Section 5 otherwise known as the Very Inflated zone. In this case, options for Yahoo in general will be determined to be overpriced by valuation assessment engine 230 and trade signal generator 290 will generate recommended trades based thereupon. In some embodiments, rather than IV being calculated for a collective set of options tied to a specific underlying asset, IV may be calculated with respect to a single option based on the specific price of that option and using the Black-Scholes formula to determine the IV for that option. In this case, the valuation of that specific option will be assessed by valuation assessment engine 230 and trades recommended by trade signal generator 290 will take that into account.

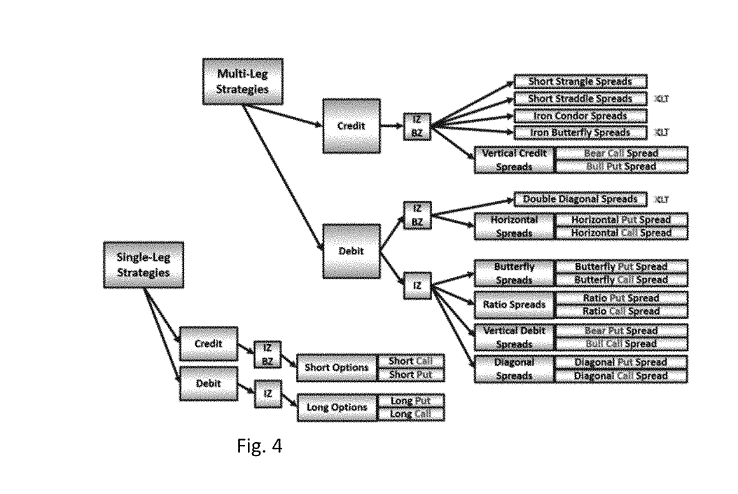

With reference now to FIG. 4, a diagram illustrating various options trading strategies is presented. These strategies are merely exemplary. This database of available strategies and others is available to trade signal generator 290 along with valuation input provided by valuation assessment engine 230. In addition, users and/or administrators may provide additional input to trade signal generator 290 through user interface 210 to configure desired/available trades. For example, users might interact with the system to limit the recommended strategies to single leg strategies and to exclude any recommendations involving multi-legs. Similarly, users may configure the system to control positions sizes based on available and deployable capital as well as control of risk (e.g. only strategies with a higher probably of success trading off lower possible return may be allowed). With each of the foregoing inputs (valuation, available strategies and configuration/preference information), trade signal generator 290 can generate customized recommended trades (and adjustments) for users on a real time or at least near real time basis.

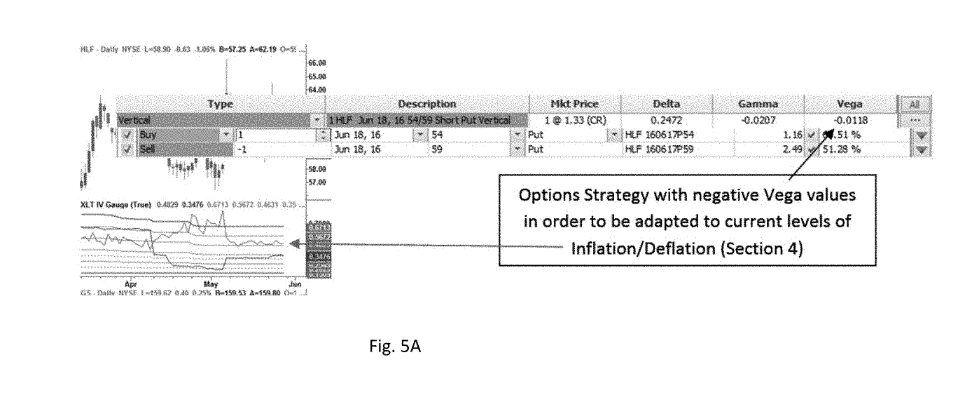

Turning now to FIG. 5A, a depiction of an options trade and various parameters associated therewith is provided. In this case, options trading subsystem 100 has previously generated a trade which is a vertical spread. Alternatively, the trade may have been entered manually with options trading system being used in the capacity of maintaining the trade and recommending adjustments as needed. In any event, this vertical spread consists of the purchase of 1 HLF June 2016 54 Put and the sale of 1 HLF June 2016 59 Put. As shown in the vega box in FIG. 5A, a negative vega is currently calculated for the overall position.

Vega is one of the options greeks and it measures the monetary impact of having options inflate or deflate during the life of a trade. The system and methodology of the present invention provides a very precise and realistic assessment of options valuations based on their premiums at any point in time. This assessment, as discussed above, is reflected in a valuation ranging from very inflated to inflated to fairly priced to deflated to very deflated. With this in mind, the system and methodology of the present invention provides a unique ability to recommend adjustment of options strategies already in place as market conditions change.

The technical definition of vega is that it is the change in the price of an option as a result of a one percent change in the volatility of the underling trading asset (stock, currency, commodity). Thus, with a positive vega, the option price is expected to rise if volatility rises and conversely, if vega is negative, the option price will go down if volatility rises. Vega is always positive for a net long position and vega is always negative for a net short position.

In the context of FIG. 5A, vega is negative because the overall position is net short. As will be recognized by one of skill in the art, based on the above, it is desirable for an overall position to have a highly negative vega value when options are very inflated. Similarly, it is desirable for the overall position to have a slightly negative vega value when options are inflated but not very inflated. When options are fairly priced, it is desirable for overall position vega values to be neutral. When options are deflated but not very deflated, it is desirable for overall position vega to be slightly positive. And finally, when options are very deflated, it is desirable for overall position vega values to be greatly positive. This is summarized in the following chart:

| Option Valuation | Desirable Position Vega |
|---|---|
| Very Inflated | Greatly negative |
| Inflated | Negative |
| Fairly Priced | Neutral |
| Deflated | Positive |
| Very Deflated | Very positive |

In FIG. 5A, it can be seen that options valuation falls within zone 4 (Inflated). As a result, it is desirable for the overall position to be negative but not greatly negative. Given the current vega value of the position (−0.0118), options trading system 100 is likely to determine that no adjustment to the overall position is necessary or desirable.

In FIG. 5B, a different vertical spread is in place. In this case, there is 1 long GS October 160 Call along with 1 short GS October 175 Call. This is a net long spread that profits from a rise in the price of the underlying stock GS. As such, the indicated position vega is positive. In particular, the value is 0.0722. Referencing the indicated HV/IV chart, in this case, the valuation indicates that pricing is in zone 2 (Deflated). As discussed above, the preference is thus for a slightly positive overall vega position value. Options trading subsystem 100 may in this case determine that the value 0.0722 is too high of a vega given a deflated valuation determination. As such, a position adjustment trade recommendation may be generated by trade signal generator 290 which results in a decrease in the overall position value to a value that remains positive but not so highly positive. By way of example, a position adjustment may involve substituting for one or both of the calls to one or more replacement calls at a different strike price.

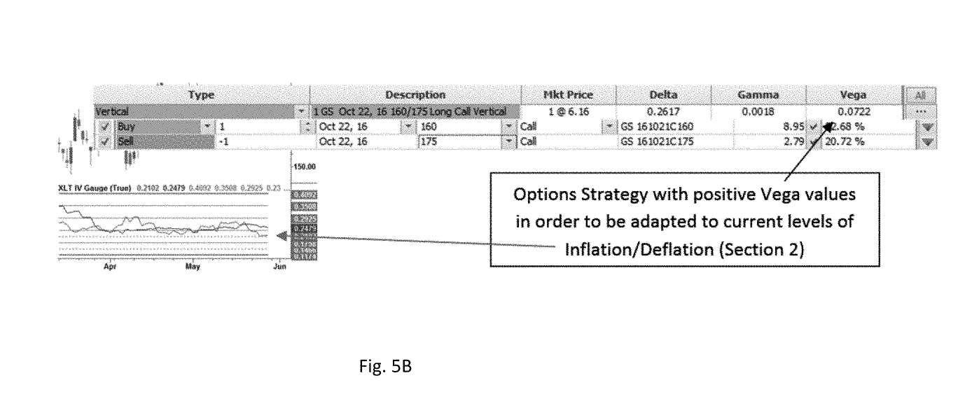

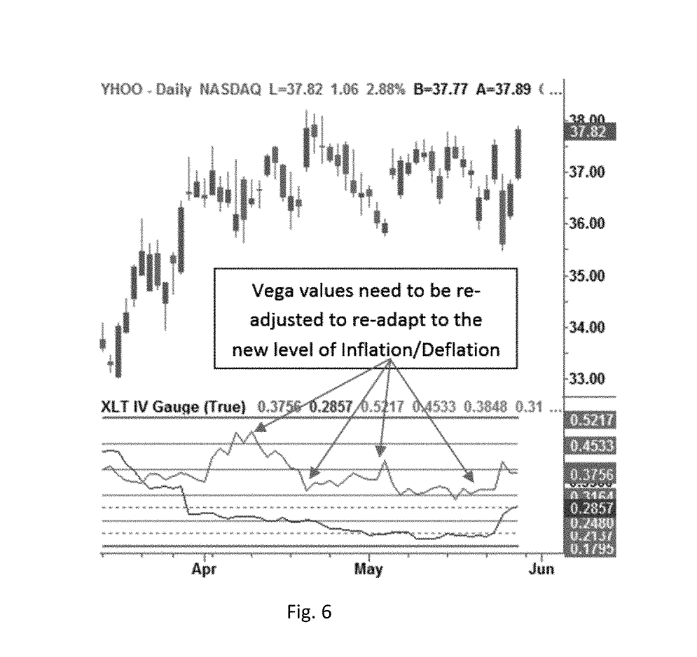

FIG. 6 is a depiction of stock movement and related IV and HV plots and provides an indication of how IV can deviate from one IV zone to another over time. As this happens, it is an indication that the valuation of the options is changing over time and if a position is in place, profitability of that position may be driven, at least to some extent by the vega value of the overall position as such value relates to the then current valuation determination. In the figure it can be seen that the valuation changes from zone 5 to zone 4 to zone 3 and then back to zone 4. At each of these changes, it is prudent to confirm that the vega value for the overall position is consistent with the preferred value given the valuation determination. This is accomplished by options trading subsystem 100 given that market data source 205 is constantly providing updated data so that the system will determine, for example, when valuation changes from one zone to the next for a position.

In this example, when valuation changes, for example from zone 5 to zone 4, options trading subsystem can cause one or more actions to occur. For example, one possibility is for the system to notify the user of this change via user interface 210 thus allowing the user to determine if he or she desires to make an adjustment. The system can then propose recommended adjustments designed to modify the vega value to the desired level. In some embodiments, the system may be configured to automatically execute one or more recommended adjustments with little or no user input.

With reference now to FIG. 7, a discussion of the high level steps undertaken by Options Trading Subsystem 100 and TOPS 600 in connection with monitoring markets and providing potential derivative trading opportunities leveraging the novel valuation determination performed is now provided. At step 910, TOPS 600 and option trading subsystem 100 therein obtain market data from any or all of market data source 205, market data #1 610, market data #2 620 and/or market data #3 630. This market data, as discussed above, may include stock pricing data, option pricing data, market data, volatility data, data respecting other derivative instruments and underlying assets as well as other data as desired.

This market data is then used by Options Trading Subsystem 100 at step 920 by HV determination engine 250 to determine the historic volatility (HV) for the applicable underlying assets according to the novel approach described herein. In particular, the HV range for each underlying asset is determined by taking the high and low HV values over a predetermined historic period such as the previous 52-week period although other time frames may also be used.

At step 925, the extreme values of HV determined at step 920 are used by valuation assessment engine 230 to establish a number of IV valuation zones. In one embodiment, five equal sized ranges/zones are created in between the extreme values determined at step 920. These zones may be represented as very inflated, inflated, fairly valued, deflated and very deflated according to one embodiment of the present invention.

At step 930, the implied volatility value for the applicable underlying asset at the current, present time is determined by IV determination engine 260. As described above, this IV value may be based on a single derivative instrument (e.g. option) or a set of derivative instruments (e.g. multiple options) deriving from the same underlying asset.

At step 940, the valuation zone associated with the current, present IV is determined by valuation assessment engine 230. This is accomplished, as described above, by determining the zone in which the value of the current, present IV value fits based on its Y-axis volatility value.

Next, at step 950, once the valuation zone for the applicable derivative instrument(s) has been determined, one or more trading strategies is recommended based thereon under the control of trade signal generator 290. As discussed above, these strategies are selected so as to leverage the valuation determination made at step 940 so as to maximize the likelihood of a profitable trade. In some cases, these recommendations apply to a new entry into a position, while in other cases, the recommendations may apply to proposed adjustments to one or more existing positions based upon changes in market conditions including changes in volatility.

At step 960, presentation control component 650 of TOPS 600 processes the recommended trades for display for the user at user terminal 690 via user interface 210.

As discussed above, step 960 may also include providing one or more notifications to a user regarding potential trading opportunities including via SMS text, via email, via web based messaging and other methodologies. Notifications may be generated on a periodic basis and/or based on other criteria selected by a user and/or an administrator. For example, a user may be notified only when volatility changes for an underlying asset to the point that the valuation zone for that underlying asset has changed.

As noted above, in some cases, a user may be permitted to invoke trade executions for one or more potential trading opportunities directly from the user terminal 690. In this case, at step 960, if an execution is requested for one or more trading opportunities, then such trade(s) are executed at step 980 and then the process ends at step 990. Alternatively, if no execution is desired and/or that capability does not exist in the system as implemented, then the process proceeds directly to step 990 and ends there.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A derivatives trading system configured to provide actionable trading signals employing at least one derivative instrument, the derivatives trading system comprising:
one or more processors configured to execute computer program modules, the computer program modules comprising:
a market data receiving module configured to receive pricing data for an underlying asset and said at least one derivative instrument, said at least one derivative instrument deriving from said underlying asset;
a historic volatility determination module configured to determine historic volatility for said underlying asset based upon the extreme high and low values of volatility associated with said underlying asset during a pre-determined historic period;
an implied volatility determination module configured to determine implied volatility of said at least one derivative instrument;
a valuation assessment module configured to assign said at least one derivative instrument to a valuation zone based on a comparison between said historic volatility and said implied volatility; and
a trade signal generation module configured to generate at least one derivative based trading recommendation based upon the assigned valuation zone of said at least one derivative instrument.

2. The derivatives trading system of claim 1 wherein said at least one derivative instrument comprises at least one option and said underlying asset comprises a stock.

3. The derivatives trading system of claim 1 wherein said at least one derivative instrument comprises at least one futures contract and said underlying asset comprises a currency.

4. The derivatives trading system of claim 1 wherein said at least one derivative instrument comprises at least one futures contract and said underlying asset comprises a commodity.

5. The derivatives trading system of claim 1 wherein said trade signal generation module generates a trade execution rather than a trade recommendation.

6. The derivatives trading system of claim 1 wherein said pre-determined historic period is a previous 52-week period.

7. The derivative trading system of claim 1 wherein an implied volatility value in excess of a historic volatility value represents a potential overvaluation for said at least one derivative instrument.

8. The derivative trading system of claim 7 wherein the extent of said potential overvaluation of said at least one derivative instrument is directly related to the extent to which said implied volatility value exceeds said historic volatility value.

9. The derivative trading system of claim 1 wherein there exists five potential valuation zones to which said at least one derivative instrument may be assigned.

10. The derivative trading system of claim 9 where said potential valuation zones comprise very deflated, deflated, fair, inflated and very inflated.

11. A method for generating actionable trading signals employing at least one derivative instrument, the method comprising the steps of:
receiving pricing data for an underlying asset and said at least one derivative instrument, said at least one derivative instrument deriving from said underlying asset;
determining historic volatility for said underlying asset based upon the extreme high and low values of volatility associated with said underlying asset during a pre-determined historic period;
determining implied volatility of said at least one derivative instrument;
assigning said at least one derivative instrument to a valuation zone based on a comparison between said historic volatility and said implied volatility; and
generating at least one derivative based trading recommendation based upon the assigned valuation zone of said at least one derivative instrument.

12. The method of claim 11 wherein said at least one derivative instrument comprises at least one option and said underlying asset comprises a stock.

13. The method of claim 11 wherein said at least one derivative instrument comprises at least one futures contract and said underlying asset comprises a currency.

14. The method of claim 11 wherein said at least one derivative instrument comprises at least one futures contract and said underlying asset comprises a commodity.

15. The method of claim 11 wherein said a trade execution is generated rather than a trade recommendation.

16. The method of claim 11 wherein said pre-determined historic period is a previous 52-week period.

17. The method of claim 11 wherein an implied volatility value in excess of a historic volatility value represents a potential overvaluation for said at least one derivative instrument.

18. The method of claim 17 wherein the extent of said potential overvaluation of said at least one derivative instrument is directly related to the extent to which said implied volatility value exceeds said historic volatility value.

19. The method of claim 11 wherein there exists five potential valuation zones to which said at least one derivative instrument may be assigned.

20. The method of claim 19 where said potential valuation zones comprise very deflated, deflated, fair, inflated and very inflated.
